(19) United States
(12) Patent Application Publication
(10) Pub. No.: US 2025/0026659 A1
(43) Pub. Date: Jan. 23, 2025

(54) APPARATUS FOR PRODUCING MAGNESIUM OXIDE

(71) Applicant: INDUSTRY ACADEMIC COOPERATION FOUNDATION OF YEUNGNAM UNIVERSITY, Gyeongsan-si, Gyeongsangbuk-do (KR)

(72) Inventors: Joo Hwan HAN, Gyeongsan-si (KR); Jung Ho RYU, Daegu (KR); Hyo Jung CHO, Daegu (KR); Su Min PARK, Daegu (KR); Hae Won JUNG, Daegu (KR)

(21) Appl. No.: 18/714,899

(22) PCT Filed: Oct. 12, 2022
(86) PCT No.: PCT/KR2022/015417

§ 371 Date: May 30, 2024

(30) Foreign Application Priority Data
Nov. 30, 2021 (KR) 10-2021-0168054
Oct. 12, 2022 (KR) 10-2022-0130500

(51) Int. Cl. C01F 5/08; B01J 2/06; B01J 6/00; C09K 5/14

(52) U.S. Cl. CPC C01F 5/08; B01J 2/06; B01J 6/001; C09K 5/14; C01P 2004/03; C01P 2004/32; C01P 2004/50; C01P 2004/61; C01P 2006/32

(57) ABSTRACT

The present application relates to an apparatus for producing magnesium oxide, a method for producing magnesium oxide by using same, magnesium oxide produced thereby, and use of the magnesium oxide. According to the apparatus for producing magnesium oxide, the method for producing magnesium oxide by using same and the magnesium oxide produced thereby of the present application, the magnesium oxide may have high thermal conductivity at low costs, a small spherical particle size, and a dense structure. Such magnesium oxide can be used as a heat-dissipating filler.

### TECHNICAL FIELD

This application relates to an apparatus of producing magnesium oxide, a method of producing magnesium oxide using the same, magnesium oxide produced using the same, and uses of the magnesium oxide.

### BACKGROUND ART

Magnesium oxide (MgO) has a thermal conductivity, which is about 2 to 3 times higher than that of aluminum oxide (Al₂O₃), and a low raw material price, so it is very cost-effective in that it has an excellent thermal conductivity compared to expensive thermally conductive materials such as aluminum nitride (AlN), beryllium oxide (BeO), silicon carbide (SiC), and boron nitride (BN).

Attempts have been made to replace aluminum oxide, which is used as a filler for heat dissipating materials, with magnesium oxide. As well as low price and high thermal conductivity, the most important condition for a heat dissipating filler is to have dense spherical particles with a particle diameter of about 150 μm or less in order to be densely filled into polymer resin. In conventional ceramic manufacturing processes, spray drying is well known as the most economical process for mass production of spherical particles with a diameter of 150 μm or less. The spray drying is a process of producing spherical solid powder lumps, that is, granules, with a diameter of tens to hundreds of um by preparing a suspension in which ceramic powder particles are uniformly dispersed in liquid and generating spherical suspension droplets with a diameter of tens to hundreds of um through a droplet generator, which is called an atomizer, and at the same time, blowing high-temperature gas into the container where the droplets are sprayed and causing evaporation of the liquid components from the droplets. Therefore, it is judged that the spray drying is the most economical and mass-producible process for producing magnesium oxide, which is promising as a heat dissipating filler, with spherical particles of about 150 μm or less.

When magnesium oxide combines with moisture or water, a hydration reaction of MgO+H₂O=Mg(OH)₂ occurs, which makes it impossible to use water, the most commonly used solvent for preparing a suspension in the common ceramic spray drying process.

To overcome this problem, a non-aqueous spray drying method that uses an alcohol-based solvent instead of water as a solvent for preparing a suspension has been conventionally adopted. However, in non-aqueous spray drying processes using organic solvents, explosion-proof spray dryers are used to prevent the explosion of suspension composed of flammable organic solvents. These explosion-proof spray dryers are more expensive than spray dryers used in aqueous spray drying processes that use water. In addition, the high-purity organic solvents consumed in large quantities are also expensive compared to distilled water in aqueous processes.

Although there are differences depending on their types, most organic solvents are harmful, so, if possible, an aqueous process is more preferable than a non-aqueous process. Therefore, there is a need for a device of producing magnesium oxide to compensate for these shortcomings.

### DISCLOSURE

### Technical Problem

The present application provides an apparatus of producing dense magnesium oxide, which has high thermal conductivity and a spherical shape with a small diameter, a method of producing magnesium oxide using the same, magnesium oxide produced using the same, and uses of the magnesium oxide.

### Technical Solution

In order to solve the above problem, the apparatus of preparing magnesium oxide of the present application includes: a mixing part that prepares a suspension by mixing distilled water, a magnesium oxide precursor powder, and an additive; a spray drying part that produces granules by spraying and drying the suspension mixed in the mixing part; and a heat treatment part that produces magnesium oxide by heat treating granules produced in the spray drying part.

The magnesium oxide precursor powder may be a magnesium hydroxide (Mg(OH)₂) powder.

The magnesium oxide precursor powder may be included in an amount of 25 parts by weight to 70 parts by weight based on 100 parts by weight of the suspension.

The additive may include one or more selected from a dispersant, a sintering additive, and an agent to improve thermal properties.

The dispersant may be included in an amount of 0.1 parts by weight to 10 parts by weight based on 100 parts by weight of the magnesium oxide precursor powder.

The sintering additive may be included in an amount of 0.1 parts by weight to 0.5 parts by weight based on 100 parts by weight of the magnesium oxide precursor powder.

The agent to improve thermal properties may be included in an amount of 0.05 parts by weight to 0.45 parts by weight based on 100 parts by weight of the magnesium oxide precursor powder.

The additive may not contain one or more selected from a binder and a plasticizer.

The suspension may have a solid content of 15 vol % to 50 vol %.

Spraying and drying of the suspension may be performed simultaneously in the spray drying part.

Droplets sprayed from the spray drying part may be spherical with a diameter of 10 μm to 200 μm.

The spray drying part may include an inlet through which hot air flows and an outlet through which hot air is emitted, and the temperature of the hot air flowing into the spray drying part may be 120° C. to 180° C., and the temperature of the hot air emitted from the spray drying part may be 50° C. to 100° C.

The heat treatment may be performed at 1300° C. to 1450° C. for 5 minutes to 120minutes.

The magnesium oxide formed by the heat treatment may have a relative density of 95% or more.

The magnesium oxide formed by the heat treatment may be spherical with a particle diameter of 5 μm to 150 μm.

The magnesium oxide formed by the heat treatment may have a thermal conductivity of 40 W/m·K to 65 W/m·K.

The apparatus of producing magnesium oxide may further include a particle-size control part that adjusts the size of aggregates when aggregates are formed due to aggregation among the heat treated granules in the heat treatment part.

The method of producing magnesium oxide according to the present application relates to a method of producing magnesium oxide using the magnesium oxide production apparatus, which includes: preparing a suspension by mixing distilled water, a magnesium oxide precursor powder, and an additive; spraying and drying the suspension mixed in the mixing step to produce granules; and heat treating granules produced in the spray drying step to produce magnesium oxide.

The spray drying step may be for spraying and drying the suspension simultaneously.

The magnesium oxide production method may further include adjusting the particle size of aggregates when aggregates are formed due to aggregation among the heat treated granules in the heat treatment part.

Magnesium oxide of the present application is produced using the magnesium oxide production apparatus.

A heat dissipating filler of the present application includes the magnesium oxide.

### Advantageous Effects

According to the magnesium oxide production apparatus of the present application, the method of producing magnesium oxide using the same, and magnesium oxide produced using the same, magnesium oxide can have high thermal conductivity, a spherical shape with a small diameter and a dense structure at low prices. This magnesium oxide can be used as a heat dissipating filler.

### DESCRIPTION OF DRAWINGS

FIG. 1 is an exemplary diagram illustrating a process for producing magnesium oxide using an apparatus of producing magnesium oxide according to an embodiment of the present application.

FIG. 2 is a photograph of the magnesium hydroxide granules of Example 1, taken with a scanning electron microscope and magnified 500 times.

FIG. 3 is a photograph of the magnesium hydroxide granules of Example 1, taken with a scanning electron microscope and magnified 1500 times.

FIG. 4 is a photograph of the magnesium hydroxide granules of Comparative Example 1, taken with a scanning electron microscope and magnified 100 times.

FIG. 5 is a photograph of the magnesium hydroxide granules of Comparative Example 1, taken with a scanning electron microscope and magnified 1000 times.

FIG. 6 is a photograph of the magnesium oxide particles of Example 1 taken with a scanning electron microscope and magnified 500 times.

FIG. 7 is a photograph of the magnesium oxide particles of Example 1 taken with a scanning electron microscope and magnified 1500 times.

FIG. 8 is a photograph of the magnesium oxide particles of Example 2 taken with a scanning electron microscope and magnified 500 times.

FIG. 9 is a photograph of the magnesium oxide particles of Example 2 taken with a scanning electron microscope and magnified 1500 times.

FIG. 10 is a photograph of the magnesium oxide particles of Comparative Example 2 taken with a scanning electron microscope and magnified 200 times.

FIG. 11 is a photograph taken with a scanning electron microscope and magnified 500 times to analyze primary granule defects in the magnesium oxide particles of Example 2.

FIG. 12 is a photograph taken with a scanning electron microscope and magnified 1500 times to analyze primary granule defects in the magnesium oxide particles of Example 2.

FIG. 13 is a photograph taken with a scanning electron microscope and magnified 500 times to analyze primary granule defects in the magnesium oxide particles before sieving in Example 3.

FIG. 14 is a photograph taken with a scanning electron microscope and magnified 1500 times to analyze primary granule defects in the magnesium oxide particles before sieving in Example 3.

FIG. 15 is a photograph taken with a scanning electron microscope and magnified 500 times to analyze primary granule defects in the magnesium oxide particles after sieving in Example 3.

FIG. 16 is a photograph taken with a scanning electron microscope and magnified 1500 times to analyze primary granule defects in the magnesium oxide particles after sieving in Example 3.

FIG. 17 is a photograph taken with a scanning electron microscope and magnified 500 times to analyze secondary granule defects in the magnesium oxide particles of Example 2.

FIG. 18 is a photograph taken with a scanning electron microscope and magnified 1500 times to analyze secondary granule defects in the magnesium oxide particles of Example 2.

FIG. 19 is a photograph taken with a scanning electron microscope and magnified 500 times to analyze secondary granule defects in the magnesium oxide particles of Comparative Example 1.

FIG. 20 is a photograph taken with a scanning electron microscope and magnified 2000 times to analyze secondary granule defects in the magnesium oxide particles of Comparative Example 1.

FIG. 21 is a photograph taken with a scanning electron microscope and magnified 200 times to analyze secondary granule defects in the magnesium oxide particles of Comparative Example 2.

### BEST MODES OF THE INVENTION

Hereinafter, the apparatus of producing magnesium oxide of the present application will be described with reference to the attached drawings. The attached drawings are illustrative and the apparatus of producing magnesium oxide of the present application is not limited thereto.

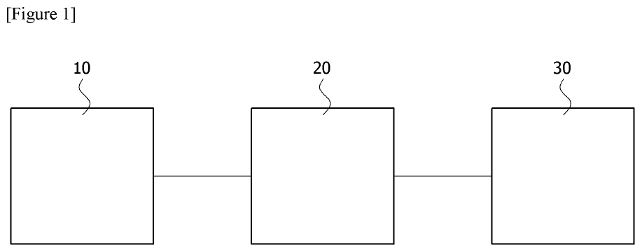

FIG. 1 is an exemplary diagram illustrating a process for producing magnesium oxide using an apparatus of producing magnesium oxide according to an embodiment of the present application. As shown in FIG. 1, the apparatus of producing magnesium oxide includes a mixing part 10, a spray drying part 20, and a heat treatment part 30. According to the apparatus of producing magnesium oxide of the present application, magnesium oxide may have high thermal conductivity at low prices, a spherical shape with a small diameter, and a dense structure.

The mixing part is for preparing a suspension by mixing distilled water, a magnesium oxide precursor powder, and an additive. Specifically, the mixing may be performed by mixing the distilled water and the additive in a container first, and then adding the magnesium oxide precursor powder to the mixture. For example, the mixing method may include various grinding and mixing methods used in conventional ceramic processes, and specifically, stirring, ultrasonication, ball milling, attrition-milling, bead-milling, vibratory milling, or planetary milling may be used.

In an embodiment, the mixing is performed using ball milling, and for sufficient reduction of the size of the magnesium oxide precursor powder and uniform mixing, balls with a diameter of 5 to 10 mm, such as a zirconia ball, may be used for ball milling for 12to 24 hours.

The magnesium oxide precursor powder may be magnesium hydroxide (Mg(OH)₂) powder. By using the magnesium hydroxide (Mg(OH)₂) powder, a hydration reaction does not occur even when it combines with distilled water, so an aqueous spray drying process may be used.

The magnesium oxide precursor powder may be included in an amount of 25 parts by weight to 70 parts by weight based on 100 parts by weight of a suspension. Specifically, the magnesium oxide precursor powder may be included in an amount of 30 parts by weight to 68 parts by weight, 35 parts by weight to 66 parts by weight, 40 parts by weight to 64 parts by weight, 45 parts by weight to 62 parts by weight, 50 parts by weight to 60 parts by weight, or 55 parts by weight to 60 parts by weight, based on 100 parts by weight of a suspension. When the magnesium oxide precursor powder is included in the above-described content in the suspension, the spray drying process may be performed smoothly, and the production yield of granules with an appropriate diameter may be improved. On the other hand, when the magnesium oxide precursor powder is included less than the above-described content, the diameter of the produced granules may become small and the production yield of granules may decrease. When the magnesium oxide precursor powder is included more than the above-described content, the viscosity of the suspension may increase, making it impossible to perform spray drying.

The additive may include one or more selected from a dispersant, a sintering additive, and an agent to improve thermal properties.

Specifically, as the dispersant, it is possible to use various aqueous dispersants that are commonly used to prepare an aqueous ceramic suspension, and for example, an polycarboxylic acid ammonium salt (5468CF from Sannopco), aqueous ammonia (NH₄OH), polyoxyethylene nonylphenyl ether, branched phosphate (RE-610 from Solvay Rhodafac), DISPERBYK-194, or DISPERBYK-6230 may be used.

The dispersant content may be 0.1 parts by weight to 10 parts by weight, 1 part by weight to 9 parts by weight, 3 parts by weight to 8 parts by weight, or 5 parts by weight to 7 parts by weight, based on 100 parts by weight of the magnesium oxide precursor powder. By including the dispersant in the above-described amount, the dispersibility of the magnesium hydroxide powder particles distributed in the suspension may be improved, the viscosity may be reduced, thereby making it possible to prepare a high-concentration, low-viscosity suspension.

As the sintering additive, any substance, which is known to promote sintering of magnesium oxide, may be used, and for example, titanium oxide (TiO₂), niobium (Nb₂O₅), zirconia (ZrO₂), gallium oxide (Ga₂O₃), dimanganese trioxide (Mn₂O₃), vanadium pentoxide (V₂O₅), tantalum pentoxide (Ta₂O₅), antimony pentoxide (Sb₂O₅), yttrium oxide (Y₂O₃), europium oxide (Eu₂O₃), erbium oxide (Er₂O₃), boron trioxide (B₂O₃), iron oxide (Fe₂O₃), tin oxide (SnO₂), manganese dioxide (MnO₂), silicon dioxide (SiO₂) or alumina (Al₂O₃) may be used.

The sintering additive content may be 0.1 parts by weight to 0.5 parts by weight or 0.2 parts by weight to 0.4 parts by weight, based on 100 parts by weight of the magnesium oxide precursor powder. When the sintering additive is included in the above-described content, it is possible to increase densification of magnesium oxide.

As the agent to improve thermal properties, any substance, which is known to improve the thermal conductivity of magnesium oxide, may be used, and for example, niobium (Nb₂O₅), titanium oxide (TiO₂), zirconia (ZrO₂), yttrium oxide (Y₂O₃), europium oxide (Eu₂O₃), erbium oxide (Er₂O₃), or alumina (Al₂O₃), which acts as a sintering additive and improves thermal properties simultaneously, may be used.

The content of the agent to improve thermal properties may be 0.05 parts by weight to 0.45 parts by weight, 0.1 parts by weight to 0.4 parts by weight, 0.15 parts by weight to 0.35 parts by weight, or 0.2 parts by weight to 0.3 parts by weight, based on 100 parts by weight of the magnesium oxide precursor powder. When the agent to improve thermal properties is included in the above-described content, it may be advantageous in that the thermal conductivity of magnesium oxide is increased.

In an example, the additive may not include one or more selected from a binder and a plasticizer. Specifically, an organic additive such as a binder and a plasticizer may be additionally added in order to ensure that a molded body, which is produced when granules produced by spray drying are molded during the conventional manufacturing of a ceramic suspension by a method such as press molding, may sufficiently withstand the stress and strain without being damaged during follow-up processes. However, when the manufacturing process of the molded body is not required as in the present invention, there is no need to additionally add additives other than the above-mentioned additives, such as one or more organic additives selected from a binder and a plasticizer.

The suspension may have a solid content of 15 vol % to 50 vol %. Specifically, the solid content of the suspension may be 20 vol % to 45 vol %, 25 vol % to 40 vol %, or 30 vol % to 40 vol %. When the suspension has the above-described solid content, it may be advantageous for producing granules in the spray drying part. On the other hand, when the suspension has a solid content less than the above-described content, a problem may occur in that the diameter of the granules, which are produced after spray drying in the spray drying part, becomes smaller. In addition, when the suspension has a solid content exceeding the above-described content, the viscosity of the suspension may become too high, and thus, it is difficult to spray droplets.

The spray drying part is for producing granules and performed by spraying and drying the suspension mixed in the mixing part. In this specification, granules are secondary particles formed by combining very fine primary particles weakly. For example, the primary particles may have a diameter of 1 μm or less, and the secondary particles may have a diameter of more than 1 μm to less than 1000 μm.

For example, the spraying may be performed using a nozzle-type atomizer or a rotating disc-type atomizer. When the spray drying part includes a nozzle-type atomizer, it is possible to control the diameter, yield and the incidence of shape defects of droplets and granules by adjusting the spray pressure of the nozzle, the speed of supplying the suspension to the spray drying part, the temperature and the speed of the hot air entering and flowing out of the spray drying part. Meanwhile, when the spray drying part includes a disc-type atomizer, it is possible to control the diameter, yield and the incidence of shape defects of droplets and granules by adjusting the rotation speed and diameter of the disc, the speed of supplying the suspension to the spray drying part, the temperature and the supply speed of hot air entering and flowing out of the spray drying part.

In an example, the spray drying part may spray and dry a suspension simultaneously. Specifically, the suspension may be sprayed and dried simultaneously through the spray drying part. By spraying and drying the suspension simultaneously, the spray drying part may dry and granulate the suspension in the form of droplets within a very short time, for example, within 1 second, which makes it possible to economically mass produce granules.

The droplets sprayed from the spray drying part may be spherical with a diameter of 10 μm to 200 μm. Specifically, the droplets sprayed from the spray drying part may be spherical with a diameter of 15 μm to 190 μm, 20 μm to 180 μm, or 25 μm to 170 μm. The droplets may be in the state of a suspension that is sprayed before being dried in the spray drying part. The droplets sprayed from the spray drying part have a spherical shape with the above-described diameter, so the size of the granules formed after drying the droplets may be 5 μm to 150 μm. Thus, the granules have good fluidity, and the agglomeration among granules during follow-up processes may be minimized. In this specification, the term “diameter” may be the size of a spherical particle.

The spray drying part may include an inlet (not shown) through which hot air flows and an outlet (not shown) through which hot air is emitted in order to dry the suspension. For example, the temperature of hot air flowing into the spray drying part may be 120° C. to 180° C., 130° C. to 170° C., or 140° C. to 160° C., and the temperature of hot air flowing out of the spray drying part may be 50° C. to 100° C., 60° C. to 90° C., or 70° C. to 80° C. When the drying is performed under the above-described conditions, the yield of granules with a good spherical shape and diameter may be increased.

The heat treatment part is for producing magnesium oxide by sintering magnesium hydroxide granules and performed by heat treating the granules produced in the spray drying part. In this specification, magnesium oxide formed by heat treatment may also be called sintered granules.

In an example, the heat treatment may be performed at 1300° C. to 1450° C. for 5 to 120 minutes. Specifically, the heat treatment may be performed at 1400° C. to 1450° C. for 30 minutes to 90 minutes. When the granules are heat treated under the above-described conditions in the heat treatment part, thermal decomposition and densification of magnesium hydroxide may be achieved.

The magnesium oxide formed by the heat treatment may have a relative density of 95% or more. When the magnesium oxide formed by the heat treatment has the relative density described above, densification may be realized.

The magnesium oxide formed by the heat treatment may be spherical with a diameter of 5 μm to 150 μm. Specifically, the spherical particles of the magnesium oxide formed by the heat treatment may have a diameter of 10 μm to 120 μm, 20 μm to 90 μm, or 30 μm to 60 μm. When the magnesium oxide formed by the heat treatment has a spherical shape with the above-described diameter, it may be used as a heat dissipating filler.

The magnesium oxide formed by the heat treatment may have a thermal conductivity of 40 W/m·K to 65 W/m·K. Specifically, the thermal conductivity of the magnesium oxide formed by the heat treatment may be 45 W/m·K to 60 W/m·K. When the magnesium oxide formed by the heat treatment has the above-described thermal conductivity, it may be used as various heat dissipating fillers.

In an example, the apparatus of producing magnesium oxide may further include a particle-size control part (not shown). The particle-size control part is for adjusting the size of aggregates when the granules heat treated in the heat treatment part are aggregated. Specifically, during the heat treatment of granules in the heat treatment part, densification occurs not only inside the granules but also on the contact surfaces between granules, and aggregates may be formed due to necking, so the size of aggregates may be adjusted to produce magnesium oxide particles with a desired diameter. For example, the particle-size control part, the size of the particles, that is, the diameter, may be adjusted by gently crushing the aggregates using a mortar and sieving them.

The present application also relates to a process of producing magnesium oxide. An exemplary method of producing magnesium oxide relates to a method of producing magnesium oxide using the apparatus of producing magnesium oxide described above. Therefore, the detailed description of the method of producing magnesium oxide described later will be omitted because the content of the above-described apparatus of producing magnesium oxide may be applied as is.

The method of producing magnesium oxide includes mixing, spray drying, and heat treating. According to the method of producing magnesium oxide, it is possible to produce dense magnesium oxide having high thermal conductivity at low prices and a small diameter.

The mixing step is for preparing a suspension and performed by mixing distilled water, a magnesium oxide precursor powder, an additive. Since the detailed description of the mixing step is the same as that described in the mixing part, it will be omitted.

The spray drying step is for producing granules and performed by spraying and drying the suspension mixed in the mixing step. Since the detailed description of the spray drying step is the same as that described in the spray drying part, it will be omitted.

In an example, the spray drying step may be for spraying and drying a suspension simultaneously. Since the detailed description of the spraying and drying performed simultaneously in the spray drying step is the same as that described in the spray drying part, it will be omitted.

The heat treatment step is for forming magnesium oxide and performed by heat treating the granules produced in the spray drying step. Since the detailed description of the heat treatment step is the same as that described in the heat treatment part, it will be omitted.

In an example, the method of producing magnesium oxide may further include a particle-size control step. The particle-size control step is for adjusting the size of aggregates when the aggregates are formed due to agglomeration between the heat treated granules in the heat treatment step. Since the detailed description of the particle-size control step is the same as that described in the particle-size control part, it will be omitted.

The present application also relates to magnesium oxide. An example is magnesium oxide produced using the apparatus of producing magnesium oxide. Therefore, the detailed description of the magnesium oxide described later will be omitted because the content of the above-described apparatus of producing magnesium oxide may be applied as is.

The magnesium oxide is produced using the apparatus of producing magnesium oxide. The produced magnesium oxide may have high thermal conductivity, a small diameter, and achieve densification. The magnesium oxide may be used as a heat dissipating filler.

The present application also relates to uses of the magnesium oxide. An exemplary magnesium oxide may be used as a heat dissipating filler including the above-described magnesium oxide. Therefore, the detailed description of the magnesium oxide described later will be omitted because the content of the above-described apparatus of producing magnesium oxide may be applied as is.

The heat dissipating filler includes the magnesium oxide. By containing the above-described magnesium oxide, the heat dissipating filler may have high thermal conductivity and a small diameter, and realize densification.

Hereinafter, the above-described content will be described in more detail through examples and comparative examples below, but the scope of the present application is not limited by the content presented below.

### EXAMPLE 1

### Producing Magnesium Oxide

Magnesium oxide was produced using the apparatus in FIG. 1. Specifically, as a mixing part, after filling a polyethylene container with a volume of 500 ml with ZrO₂ balls with a diameter of 10 mm about half, 70 g (35.9 wt %) of high purity distilled water and 8 g (4.1 wt %) of a dispersant (APCA 32.5% solution) were added for uniform mixing, and then ball milling was performed for about 3 minutes. Afterward, 0.24 g (0.1 wt %) of rutile titanium oxide powder (TiO₂) and 0.21 g (0.1 wt %) of niobium oxide powder (Nb₂O₅, Kojundo Chem. Lab. Co., Ltd.) with a particle diameter of 1 μm or less were added to the polyethylene container and ball milling was performed for about 5 minutes. After additionally adding 116.06 g (59.5 wt %) of magnesium hydroxide powder (Mg(OH)₂, Daejung Chemicals & Metals Co., Ltd.) into the polyethylene container, ball milling was performed for about 24 hours. After additionally adding 0.58 g (0.3 wt %) of a dispersant (APCA 32.5% solution) into the polyethylene container and performing ball milling for 1 minute, it was poured into a beaker and continuously stirred to prepare a suspension for spray drying. The suspension had a solid content of 39.6 vol %.

Afterward, the suspension was supplied to a spray drying part and sprayed and dried under the conditions shown in Table 1 below to produce granules.

TABLE 1

| | Values |
|---|---|
| Inflow temperature (° C.) | 150 |
| Emission temperature (° C.) | 80 |
| Hot air flow rate (m³/min) | 0.53 |
| Spray pressure of spray drying part (kPa) | 100 |
| Spray pumping speed of spray drying part (ml/h) | 600 |

Afterward, the granules were placed in a crucible made of alumina (Al₂O₃) as a heat treatment part, and the crucible was heat treated in an electric furnace at a temperature of 1450° C. for 1 hour. The temperature increase rate was 5° C./min. During the temperature increase process, thermal decomposition of magnesium hydroxide occurred at about 300° C., and the magnesium hydroxide particles in the granules were changed into magnesium oxide particles, and at about 1100° C., densification of the converted magnesium oxide particles began, and magnesium oxide with a diameter of 35 μm was produced. Since a laboratory-scale spray drying system was used, it was confirmed that the diameter of the granules was overall smaller than that of granules produced using a general spray drying system. However, it was found that it is easy to adjust the particle size up to 150 μm using the spray drying system. In addition, particles of fine powder may be attached to the surface of the granules, which rarely occurs in a spry dryer for mass production because a separate device of collecting fine particles is installed.

### EXAMPLE 2

### Producing Magnesium Oxide

Magnesium oxide with a diameter of 35 μm was produced in the same manner as in Example 1 using the apparatus of producing magnesium oxide of Example 1, except that the solid content was changed to 34.6 vol %, and a solution prepared by mixing SN5468CF from Sannopco and aqueous ammonia (28%) in a 3:5 ratio was used as a dispersant, and the heat treatment temperature was changed to 1400° C.

### EXAMPLE 3

### Producing Magnesium Oxide

When the magnesium oxide produced in Example 2 was agglomerated, the magnesium oxide produced in Example 2 was mixed with alcohol, and then ball milling was performed at a low rotation speed for 30 minutes using small ZrO₂ balls with a diameter of 3 mm. The ball milled magnesium oxide slurry was poured to a No. 635 sieve (with grit size of 20 μm) and sieved while generating ultrasonic vibrations to produce magnesium oxide with a diameter of 40 μm.

### Comparative Example 1

### Producing Magnesium Oxide

Magnesium oxide with a diameter of 80 μm was produced in the same manner as in Example 1 using the apparatus of producing magnesium oxide of Example 1, except that magnesium oxide (MgO) was used instead of magnesium hydroxide (Mg(OH)₂) as the raw material powder, iso-propyl alcohol (Daejung Chemicals & Metals Co., Ltd.) was used as the solvent, BYK-145 was used as the dispersant at 1.5 parts by weight based on 100 parts by weight of MgO powder, the solid content was changed to 32.5 vol %, and the heat treatment temperature was changed to 1400° C.

### Comparative Example 2

### Producing Magnesium Oxide

A suspension was prepared in the same manner as in Example 1 using the mixing part of Example 1, except that the solid content was changed to 25.5 vol %.

Afterward, the suspension was poured into a beaker containing a magnetic bar for stirring, stirred using a hot-plate at 95° C. to 115° C. until the suspension completely lost its fluidity, and dried to evaporate the liquid component in the suspension. Afterward, for complete drying, the beaker containing the suspension was put in an oven at 90° C., dried for 12 hours, and the dried powder cake was crushed in an alumina mortar and sieved using a #50 sieve to obtain magnesium hydroxide granules. The grinding and sieving the powder cake is for producing magnesium hydroxide granules with a size of tens to hundreds of μm.

Afterward, the magnesium hydroxide granules were heat treated in the same manner as in Example 1 using the heat treatment part of Example 1 to produce magnesium oxide with a particle size of about 100 μm. The size of the particles is the average size of the major and minor axes.

### Experimental Example 1. Shape Analysis

The magnesium hydroxide granules and magnesium oxide particles produced in Examples and Comparative Examples were photographed with a scanning electron microscope to analyze their shapes.

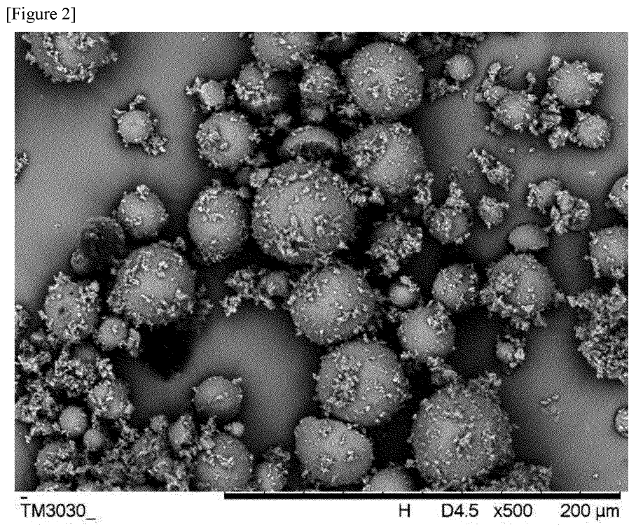

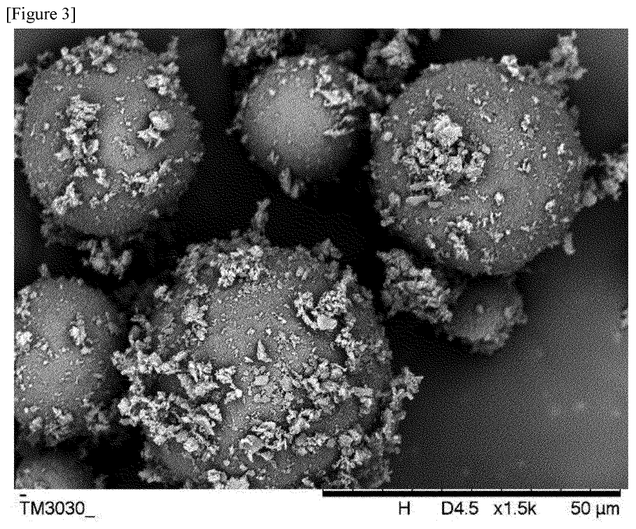

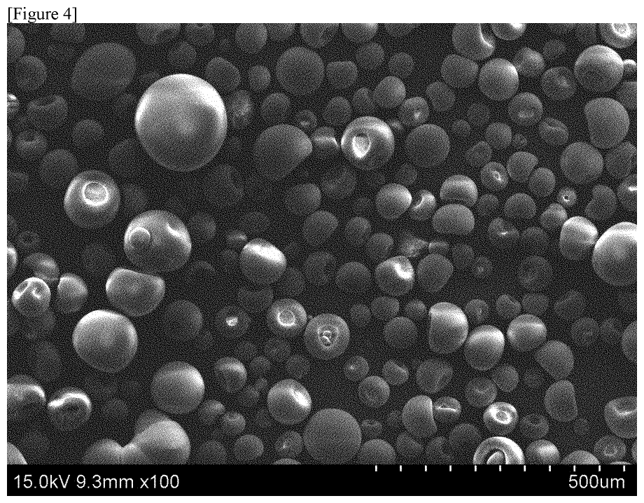

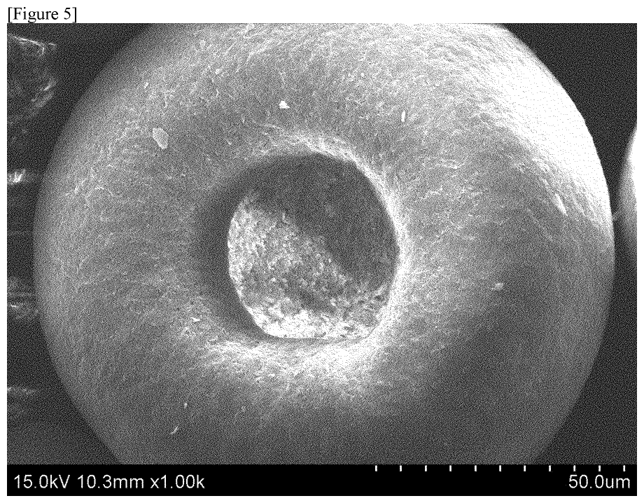

As a result, as shown in FIG. 2 and FIG. 3, it was confirmed that the magnesium hydroxide granules of Example 1 had a spherical shape with a diameter of 15 μm to 60 μm. However, as shown in FIG. 4 and FIG. 5, it was confirmed that the magnesium hydroxide granules of Comparative Example 1 were hollow or dimple-shaped and had a particle size of 20 μm to 100 μm.

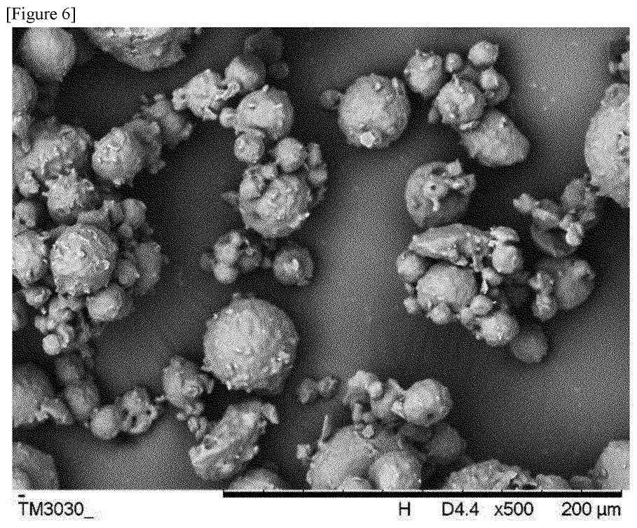

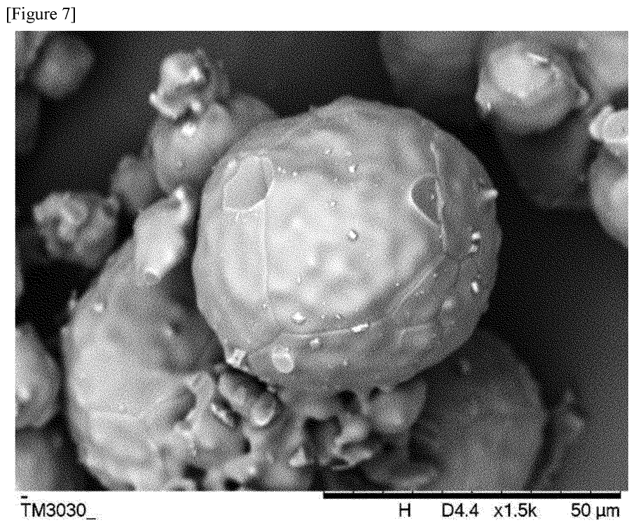

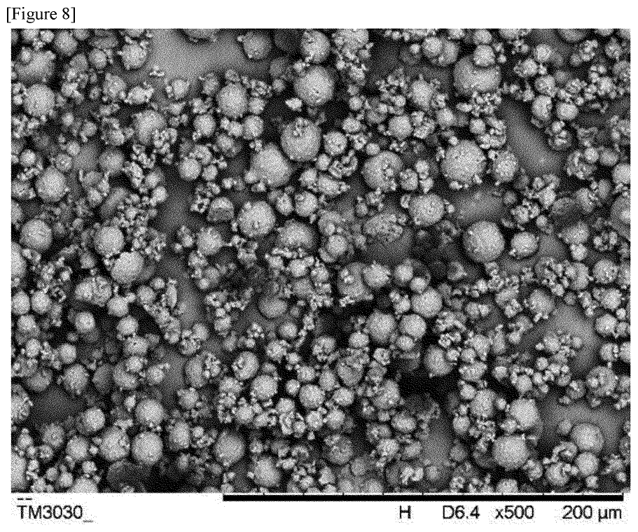

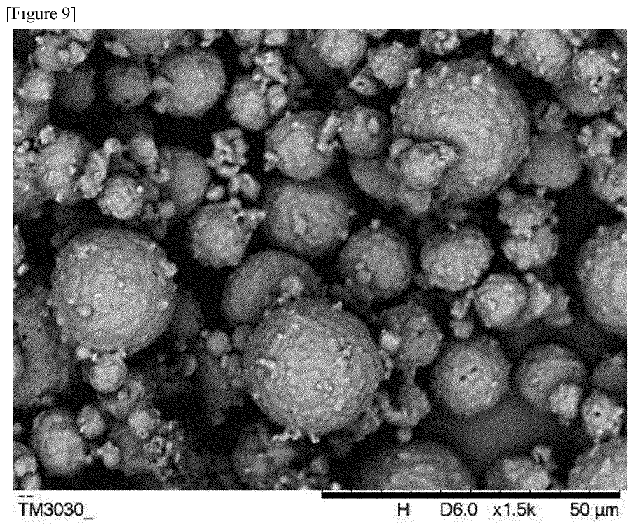

As shown in FIG. 6 and FIG. 7, it was confirmed that the magnesium oxide particles of Example 1 had a dense spherical shape with a diameter of 10 μm to 50 μm. As shown in FIG. 8 and FIG. 9, it was confirmed that the magnesium oxide particles of Example 2 had a dense spherical shape with a diameter of 5 μm to 40 μm.

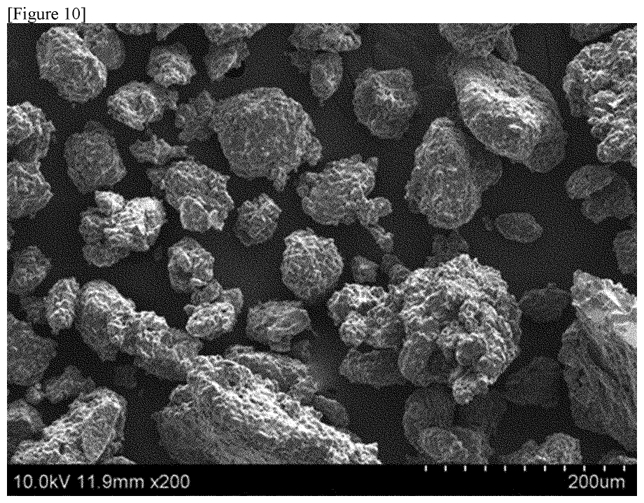

On the other hand, as shown in FIG. 10, it was confirmed that the magnesium oxide particles of Comparative Example 2 had weird irregular shapes rather than a spherical shape. This was because the suspension was directly dried rather than using the spray process of spraying the suspension to form spherical droplets by surface tension such as the spray drying in Examples. Therefore, it was confirmed that it was very difficult to produce sintered magnesium oxide granules with a good spherical shape using the method of producing magnesium oxide particles in Comparative Example 2.

### Experimental Example 2. Primary Granule Defect Analysis

In order to check for defects (hollow or dimple) in the magnesium hydroxide granules produced in Examples and Comparative Examples, the magnesium oxide particles produced in Examples and Comparative Examples were slightly shocked with a mortar rod in a mortar to destroy some of them and observed with a scanning electron microscope.

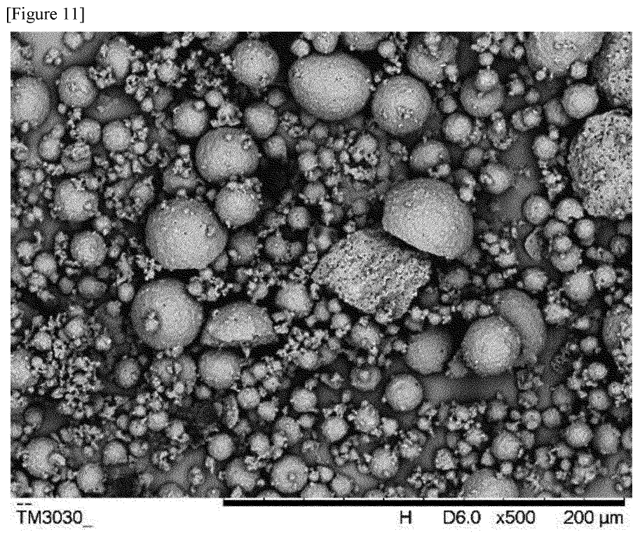

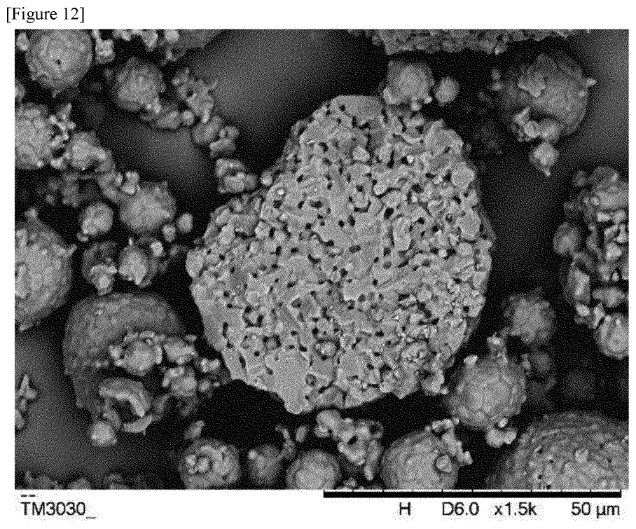

As a result, as shown in FIG. 11 and FIG. 12, it was confirmed that the magnesium oxide particles produced in Example 2 were filled with magnesium oxide without any empty space inside. When observed with a scanning electron microscope, it seemed that magnesium oxide particles didn't have a spherical shape because some magnesium oxide particles destroyed by the mortar rod were included, but in fact, it was confirmed that the magnesium oxide particles were originally spherical particles.

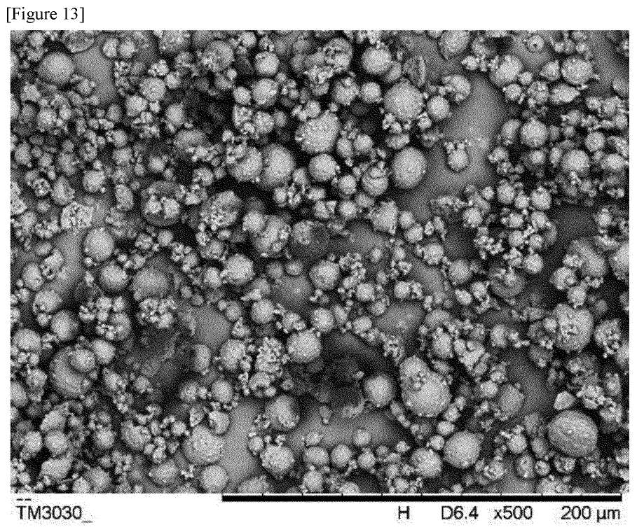

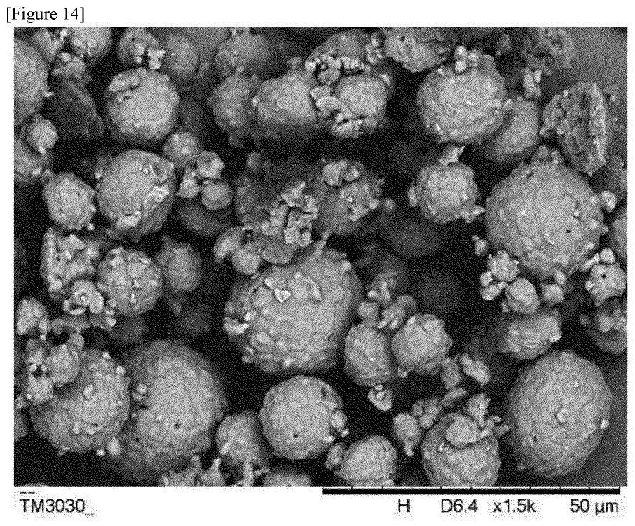

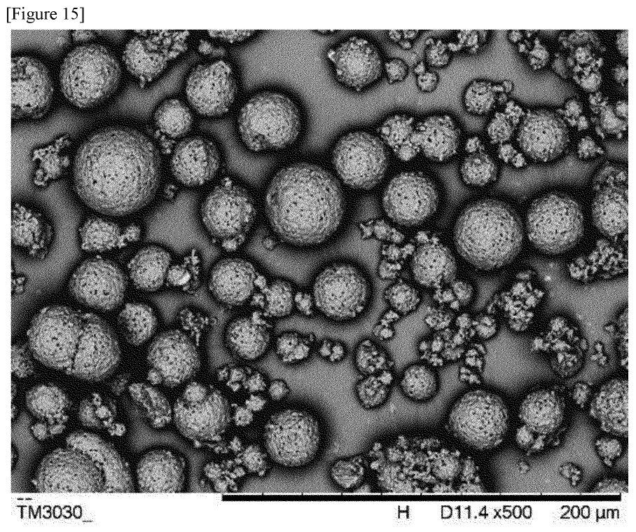

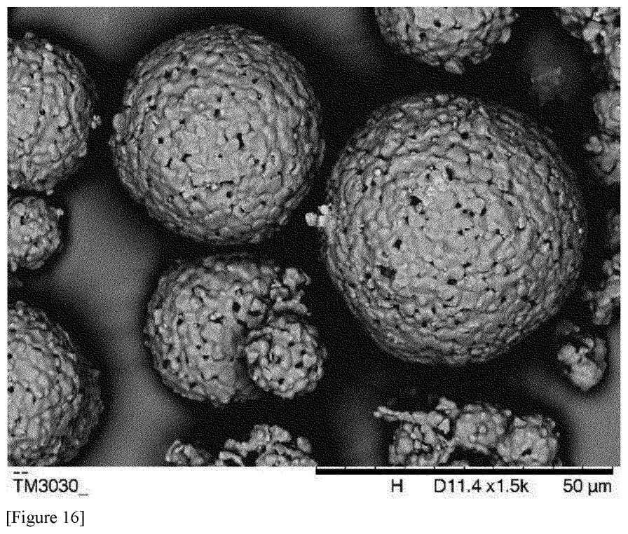

Compare to the magnesium oxide particles before sieving produced in Example 3, shown in FIG. 13 and FIG. 14, it can be seen that the magnesium oxide particles after sieving produced in Example 3, shown in FIG. 15 and FIG. 16, had a diameter of 40 μm or less, and it was possible to easily classify magnesium oxide particles.

### Experimental Example 3. Secondary Granule Defect Analysis

In order to thoroughly check the defect of the magnesium hydroxide granules produced in Examples and Comparative Examples, after filling a small amount of the magnesium oxide particles produced in Examples and Comparative Examples into pipette tips (Precision Pipette Tips, PCR-200), a room temperature curing-type epoxy resin (Epoxy Mount Resin and its Hardener from Allied High Tech Products, Inc.) was filled to impregnate and cure it, and then the tip was cut, and the cross section was polished using No. 1200 sandpaper and 1 μm and 6 μm diamond abrasives, and then it was observed with a scanning electron microscope.

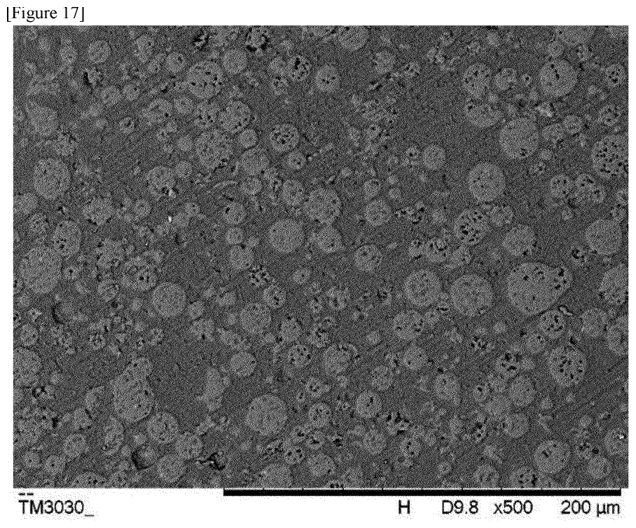

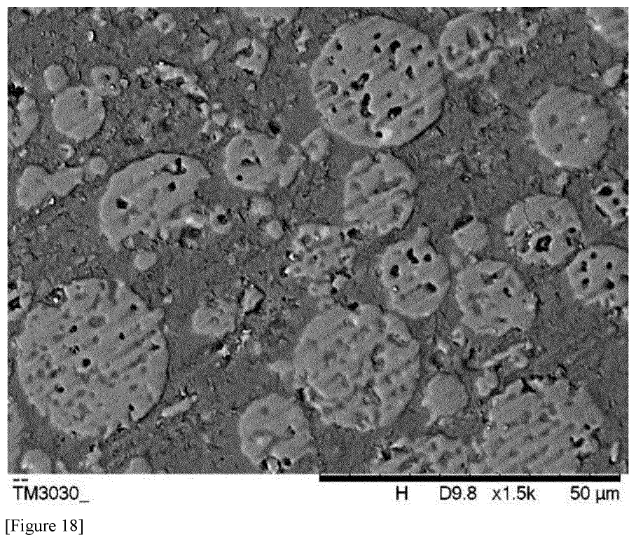

As shown in FIG. 17 and FIG. 18, it was confirmed that almost all of the magnesium oxide particles produced in Example 2 had a spherical shape, and they were fully filled without hollow or dimple defects.

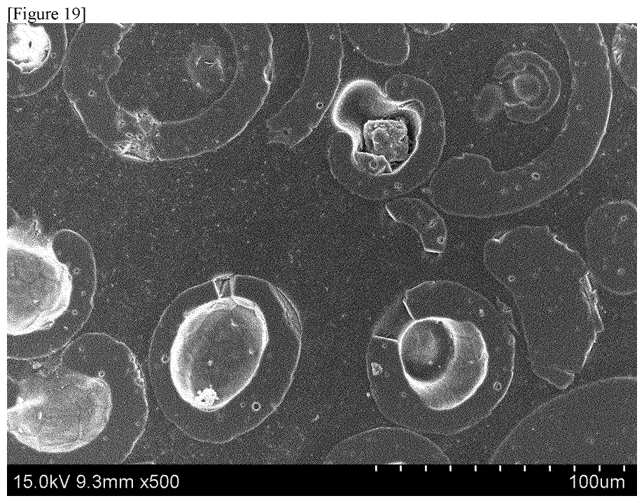

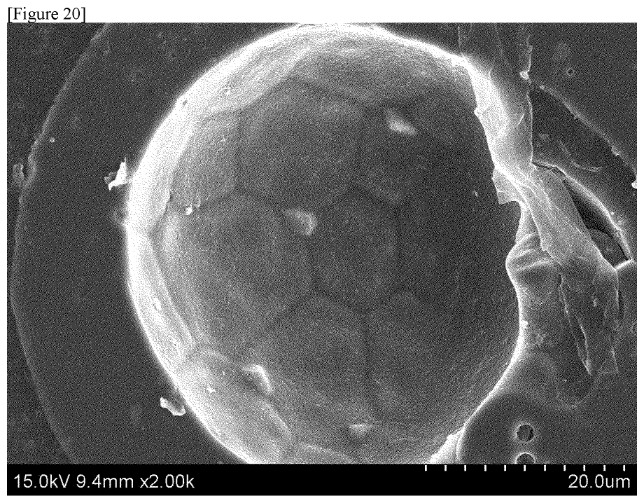

As shown in FIG. 19 and FIG. 20, it was confirmed that the magnesium oxide particles produced in Comparative Example 1 had a horseshoe-like shape with a hollow interior.

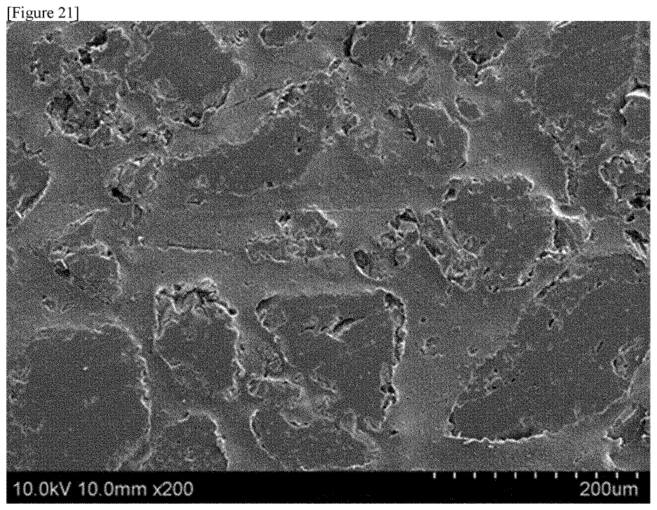

As shown in FIG. 21, it was confirmed that the magnesium oxide particles produced in Comparative Example 2 had relatively good densification, but the cross section of the particles had irregular shapes rather than a spherical shape. Therefore, it was confirmed that it was very difficult to produce sintered magnesium oxide granules having a good spherical shape using the method of producing magnesium oxide particles in Comparative Example 2.

### EXPLANATION OF SYMBOLS

10: Mixing part
20: Spray drying part
30: Heat treatment part

1. An apparatus of producing magnesium oxide, comprising:
a mixing part that prepares a suspension by mixing distilled water, a magnesium oxide precursor powder, and an additive;
a spray drying part that produces granules by spraying and drying the suspension mixed in the mixing part; and
a heat treatment part that produces magnesium oxide by heat treating granules produced in the spray drying part.

2. The apparatus of claim 1, wherein the magnesium oxide precursor powder is a magnesium hydroxide (Mg(OH)₂) powder.

3. The apparatus of claim 1, wherein the magnesium oxide precursor powder is included in an amount of 25 parts by weight to 70 parts by weight based on 100 parts by weight of the suspension.

4. The apparatus of claim 1, wherein the additive includes one or more selected from a dispersant, a sintering additive, and an agent to improve thermal properties.

5. The apparatus of claim 4, wherein the dispersant is included in an amount of 0.1 parts by weight to 10 parts by weight based on 100 parts by weight of the magnesium oxide precursor powder.

6. The apparatus of claim 4, wherein the sintering additive is included in an amount of 0.1 parts by weight to 0.5 parts by weight based on 100 parts by weight of the magnesium oxide precursor powder.

7. The apparatus of claim 4, wherein the agent to improve thermal properties is included in an amount of 0.05 parts by weight to 0.45 parts by weight based on 100 parts by weight of the magnesium oxide precursor powder.

8. (canceled)

9. The apparatus of claim 1, wherein the suspension has a solid content of 15 vol % to 50 vol %.

10. The apparatus of claim 1, wherein spraying and drying of the suspension are performed simultaneously in the spray drying part.

11. The apparatus of claim 1, wherein droplets sprayed from the spray drying part have a spherical shape with a diameter of 10 μm to 200 μm.

12. (canceled)

13. The apparatus of claim 1, wherein the heat treatment is performed at 1300° C. to 1450° C. for 5 minutes to 120 minutes.

14. The apparatus of claim 13, wherein the magnesium oxide formed by the heat treatment has a relative density of 95% or more.

15. The apparatus of claim 1, wherein the magnesium oxide formed by the heat treatment is spherical and has a particle diameter of 5 μm to 150 μm,
wherein the magnesium oxide formed by the heat treatment has a thermal conductivity of 40 W/m·K to 65 W/m·K.

16. (canceled)

17. The apparatus of claim 1, further comprising a particle-size control part that adjusts the size of aggregates when aggregates are formed due to aggregation among the heat treated granules in the heat treatment part.

18. A method of producing magnesium oxide, using the apparatus of claim 1, comprising:
mixing distilled water, a magnesium oxide precursor powder, and an additive to prepare a suspension;
spraying and drying the suspension mixed in the mixing step to produce granules; and
heat treating granules produced in the spray drying step to produce magnesium oxide.

19. The method of claim 18, wherein the spray drying step is for spraying and drying the suspension simultaneously.

20. The method of claim 18, further comprising adjusting the particle size of aggregates when aggregates are formed due to aggregation among the heat treated granules in the heat treatment part.

21. Magnesium oxide produced using the apparatus of producing magnesium oxide according to claim 1.

22. A heat dissipating filler comprising the magnesium oxide according to claim 21.
